(19) United States
(12) Patent Application Publication
(10) Pub. No.: US 2025/0061334 A1
(43) Pub. Date: Feb. 20, 2025

(54) OPTIMIZING LARGE LANGUAGE MODELS WITH DOMAIN-ORIENTED MODEL COMPRESSION

(71) Applicant: NEC Laboratories America, Inc., Princeton, NJ (US)

(72) Inventors: Yanchi Liu, Monmouth Junction, NJ (US); Wei Cheng, Princeton Junction, NJ (US); Xujiang Zhao, Hillsborough, NJ (US); Runxue Bao, Plainsboro, NJ (US); Haifeng Chen, West Windsor, NJ (US); Nan Zhang, State College, PA (US)

(21) Appl. No.: 18/805,978

(22) Filed: Aug. 15, 2024

Related U.S. Application Data
(60) Provisional application No. 63/532,924, filed on Aug. 16, 2023.
(60) Provisional application No. 63/539,681, filed on Sep. 21, 2023.

(51) Int. Cl. G06N 3/082; G06N 3/0455

(52) U.S. Cl. CPC G06N 3/082; G06N 3/0455

(57) ABSTRACT

Systems and methods for optimizing large language models (LLM) with domain-oriented model compression. Importance weights for general knowledge in a trained LLM, pretrained with deep learning, can be determined by computing the error when removing a weight from the trained LLM. The trained LLM can be iteratively optimized to obtain a domain-compressed LLM with domain knowledge while maintaining general knowledge by: fine-tuning the trained LLM iteratively with domain knowledge using the importance weights for general knowledge to obtain a fine-tuned LLM; determining importance weights for domain knowledge in the LLM with a regularization term by using gradient descent to optimize parameters when the fine-tuned LLM is trained with domain knowledge; and pruning learned knowledge based on importance weights for domain knowledge. A corrective action can be performed on a monitored entity using the domain-compressed LLM.

### RELATED APPLICATION INFORMATION

This application claims priority to U.S. Provisional App. No. 63/532,924 filed on Aug. 16, 2023, and U.S. Provisional App. No. 63/539,681 filed on Sep. 21, 2023, incorporated herein by reference in its entirety.

### BACKGROUND

### Technical Field

The present invention relates to training artificial intelligence models, and more particularly, to optimizing large language models with domain-oriented model compression.

### Description of the Related Art

Large language models (LLMs) have become ubiquitous due to the popularity of Chat-GPT™ in generating text as a trained LLM using large and diverse datasets. However, due to the scale and complexity of LLMs, it can be impractical to deploy LLMs on a computing device with limited computational resources.

Additionally, LLMs can perform general language tasks such as text generation, translation, etc., but can struggle to perform specific language tasks such as interpreting healthcare data. LLMs can be trained to perform specific language tasks but at the expense of general language tasks.

### SUMMARY

According to an aspect of the present invention, a computer-implemented method for optimizing large language models (LLM) with domain-oriented model compression is provided, including determining importance weights for general knowledge in a trained LLM, pretrained with deep learning, by computing the error when removing a weight from the trained LLM, optimizing the trained LLM iteratively to obtain a domain-compressed LLM with domain knowledge while maintaining general knowledge by, fine-tuning the trained LLM iteratively with domain knowledge using the importance weights for general knowledge to obtain a fine-tuned LLM, determining importance weights for domain knowledge in the LLM with a regularization term by using gradient descent to optimize parameters when the fine-tuned LLM is trained with domain knowledge, and pruning learned knowledge based on importance weights for domain knowledge.

According to another aspect of the present invention, a system for optimizing large language models (LLM) with domain-oriented model compression is provided, including a memory device, and one or more processor devices operatively coupled with the memory device to determine importance weights for general knowledge in a trained LLM, pretrained with deep learning, by computing the error when removing a weight from the trained LLM, optimize the trained LLM iteratively to obtain a domain-compressed LLM with domain knowledge while maintaining general knowledge by further performing steps to, fine-tune the trained LLM with domain knowledge using the importance weights for general knowledge to obtain a fine-tuned LLM, determine importance weights for domain knowledge in the LLM with a regularization term by using gradient descent to optimize parameters when the fine-tuned LLM is trained with domain knowledge, and prune learned knowledge based on importance weights for domain knowledge.

According to yet another aspect of the present invention, a non-transitory computer program product comprising a computer-readable storage medium including program code for optimizing large language models (LLM) with domain-oriented model compression, wherein the program code when executed on a computer causes the computer to determine importance weights for general knowledge in a trained LLM, pretrained with deep learning, by computing the error when removing a weight from the trained LLM, optimize the trained LLM iteratively to obtain a domain-compressed LLM with domain knowledge while maintaining general knowledge by further performing steps to fine-tune the trained LLM with domain knowledge using the importance weights for general knowledge to obtain a fine-tuned LLM, determine importance weights for domain knowledge in the LLM with a regularization term by using gradient descent to optimize parameters when the fine-tuned LLM is trained with domain knowledge, and prune learned knowledge based on importance weights for domain knowledge by removing weights that have importance scores lower than a sparsity threshold.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level overview of a method for optimizing large language models with domain-oriented model compression, in accordance with one embodiment of the present invention;

FIG. 2 is a block diagram illustrating a system for optimizing large language models with domain-oriented model compression, in accordance with an embodiment of the present invention;

FIG. 3 is a block diagram illustrating a software implementation of optimizing large language models with domain-oriented model compression, in accordance with an embodiment of the present invention;

FIG. 4 is a block diagram illustrating a practical application of optimizing large language models with domain-oriented model compression in a healthcare setting, in accordance with an embodiment of the present invention; and

FIG. 5 is a block diagram illustrating an overview of deep learning neural networks for unsupervised multi-modal causal structure learning for root cause analysis for artificial intelligence operations of a cloud system, in accordance with an embodiment of the present invention.

### DETAILED DESCRIPTION OF PREFERRED EMBODIMENTS

In accordance with embodiments of the present invention, systems and methods are provided for optimizing large language models (LLM) with domain-oriented model compression.

There can be two distinct types of learned knowledge within trained LLMs that can be retained within a compressed model framework: general knowledge and domain knowledge. General knowledge enables the trained LLM to have linguistic ability similar to natural language usage such as grammar and text identification. Domain knowledge enables the LLM to have domain-specific expertise such as healthcare data summarization. Conventional LLMs can have trouble retaining both general and domain knowledge in a compressed model. The present embodiments employ a multi-pruning mechanism that can adeptly capture and retain both these knowledge types, while selectively eliminating insignificant model parameters to obtain a domain-compressed LLM, and thus, improving the trained LLM.

In an embodiment, a domain-compressed LLM, with optimized domain knowledge while maintaining general knowledge, can be obtained by optimizing a fine-tuned LLM by iteratively pruning learned knowledge based on importance weights for domain knowledge. Importance weights for domain knowledge in the LLM can be determined by computing the weight gradient with importance estimation when the fine-tuned LLM trained with domain knowledge. The fine-tuned LLM can be obtained by fine-tuning a trained LLM iteratively with a subset of the input dataset with general knowledge regularization using importance weights for general knowledge. Importance weights for general knowledge in the trained LLM can be determined by computing the error when removing a weight from the trained LLM.

Pre-trained LLMs like GPT™ and LLaMa™ have exhibited remarkable advancements across a diverse spectrum of natural language processing (NLP) tasks. Nonetheless, these models are initially pre-trained with deep learning as they are trained on general open-domain corpora, followed by fine-tuning for generic tasks, thereby exhibiting limitations in effectively supporting domain-specific tasks. Additionally, the substantial size of LLMs causes cost-intensive deployment in real-world applications and renders them unsuitable for environments with lower computational resources. Recent approaches have introduced domain-specific LLMs and model compression techniques but fail to integrate domain-specific LLMs and model compression within a unified framework.

The present embodiments improve LLMs by having optimized domain knowledge by performing domain-specific tasks faster and more efficiently than conventional LLMs while maintaining general knowledge. The present embodiments also improve LLMs with significant reduced parameter count (e.g., half the original size or even less) making it more cost-efficient for deployment even in environment with diminished computational resources, such as resource-constrained edge computing devices. The present embodiments also improve LLMs with versatile deployment across diverse domains such as healthcare, legal, transportation, etc. which enables generation of compressed domain-specific models catering to an array of applications such as language comprehension, information extraction, and question answering.

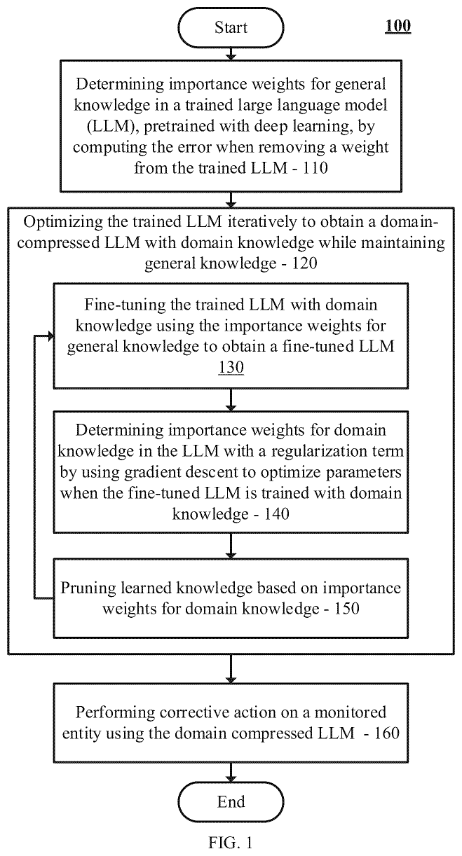

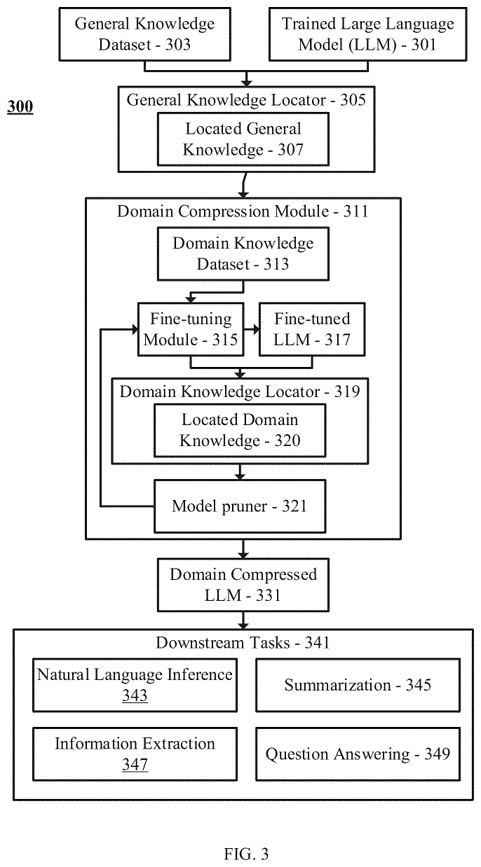

Referring now in detail to the figures in which like numerals represent the same or similar elements and initially to FIG. 1, a high-level overview of a method for optimizing large language models with domain-oriented model compression is illustratively depicted in accordance with one embodiment of the present invention. Note that the reference numbers for the features described in FIG. 1 are further described in FIG. 3.

In an embodiment, general knowledge 307 and domain knowledge 320 can be considered during optimization to maximize the performance of a domain-compressed LLM 331. The domain compressed LLM 331 can be trained in a task-agnostic fashion where a pre-training objective can be adopted, and next token prediction can be part of fine-tuning. General knowledge 307 can be considered during fine-tuning and pruning by regularization. Domain knowledge 320 can be learned through next token prediction and a multiple task-specific training data. The pruning method employed can be unstructured pruning where query, key, value, and output projections of self-attention layers, and gate, down, and up projections of multi-layer perceptrons (MLP) can be considered for pruning.

In block 110, importance weights for general knowledge in a trained large language model (LLM) can be determined by computing an error generated when removing a weight from the trained LLM.

In an embodiment, importance weights for general knowledge in a trained LLM can be determined by computing the error when removing a weight from the trained LLM 301.

General knowledge 307 can be the shared knowledge for a domain that can be learned by multiple LLMs. For example, basic language identification and grammar that can be learned by LLMs can be general knowledge 307.

For an LLM trained with general knowledge, the weights in the nodes of the LLM are assigned to parameters of an estimated function (e.g., loss function) to minimize the difference between output values of the LLM and known values from general knowledge. It can be presumed that an important weight will cause a larger increase in loss value than less important ones when the important weight is pruned (e.g., set to zero) during training. This assumption can be approximated using Taylor series. The trained LLM 301 can be trained using a small calibration general dataset to evaluate the importance weights of general knowledge.

In an embodiment, given a dataset of general knowledge domains D_{g}={xⱼ, yⱼ}ⱼ₌₁ⁿ, where n which is the dataset size used for training, and Wi stands for a weight matrix representing the importance of each weight at index m, the importance weight function can be approximated:

$${I}_{\{ {W}_{i}^{m} \}} = \vert L ( {D}_{g} ) - {L}_{{W}_{i}^{m} = 0} ( {D}_{g} ) \vert = \vert \frac{\partial L ( {D}_{q} )}{\partial {W}_{i}^{m}} {W}_{i} + \frac{1}{2} {W}_{i}^{m} {H}_{m} {W}_{i}^{m} + O ( {‖ {W}_{i}^{m} ‖}^{3} ) \vert$$

where H denotes a hessian matrix, approximated as H=XX^{T}, X^{T} is the transpose of X, and O( ) is a big-O function.

For a model trained to a local minimum on its loss curvature, the classic Optimal Brain Surgeon further approximates the error of removing weight Wᵢ^{m} as:

$${ε}_{i}^{m} = \frac{1}{2} \frac{{( {W}_{i}^{m} )}^{2}}{{[ {H}^{- 1} ]}_{m}}$$

εᵢ^{m} can also be viewed as the error caused by the removal of the weight Wᵢ^{m}.

The error of removing weight can be computed for all weights subject to pruning and a matrix of important scores Gi can be constructed with respect to general domains that have the same dimension as Wi.

The matrix of important scores Gi can be stored as the importance scores for general knowledge which can be considered to optimize the trained LLM with domain knowledge.

In block 120, the trained LLM can be optimized iteratively to obtain a domain-compressed LLM with domain knowledge while maintaining general knowledge.

In an embodiment, the trained LLM 301 can be optimized iteratively to obtain a domain-compressed LLM 331 with domain knowledge while maintaining general knowledge by iteratively fine-tuning, determining importance weights for domain knowledge, and pruning based on the importance weights for domain knowledge while considering importance weights for general knowledge.

Through iterative optimization, the domain-compressed LLM 331 can achieve better performance in domain-specific tasks with its generalization capability by updating the domain knowledge during iterative optimization while maintaining its general knowledge such as linguistic capabilities. The domain-compressed LLM 331 can also have a significantly reduced parameter count which is cost-efficient for deployment which can yield a more compact LLM. Because of its versatility, the domain-compressed LLM 331 can be seamlessly adapted to a target domain with markedly diminished computational prerequisites which can accommodate resource-constrained computing devices such as edge devices in edge computing.

The iterative optimization can be terminated when the fine-tuned LLM 317 converges to a predetermined confidence threshold. For example, the predetermined confidence threshold can be 0.9.

The iterative optimization steps are described in more detail in blocks 130, 140, and 150.

In block 130, the trained LLM can be fine-tuned with domain knowledge using the importance weights for general knowledge to obtain a fine-tuned LLM.

In an embodiment, the trained LLM can be fine-tuned with domain knowledge using the importance weights for general knowledge to obtain a fine-tuned LLM 317. The trained LLM 301 can be fine-tuned with a domain-specific dataset and to update an original loss function with a regularization term to constrain the change of important weights. Additionally, by updating the original loss function with a regularization term, it can ensure minimal update on important weights for general knowledge.

Given a domain-specific data Dₛ={xⱼ, yⱼ}ⱼ₌₁^{p}, where p is the number of domain-specific dataset, the updated loss function can be:

$$L ( {D}_{s} ) = {L}_{next} + λ {\sum }_{i = 1}^{L} [ \frac{1}{M} {\sum }_{m = I}^{M} {{G}_{i}^{m} ( {W}_{i}^{{m}^{′}} - {W}_{i}^{m} )}^{2} ]$$

where Wᵢ^{m′} denotes the updated weight value of Wᵢ^{m} after every parameter update and λ is a hyperparameter with default value of 1, Gᵢ^{m} is the importance score for the i-th node for the m-th index.

The updated loss function can be used to fine-tune the trained LLM to obtain a fine-tuned LLM that is trained with domain knowledge.

In block 140, importance weights for domain knowledge in the LLM can be determined with a regularization term by using gradient descent to optimize parameters when the fine-tuned LLM is trained with domain knowledge.

In an embodiment, importance weights for domain knowledge 320 in the LLM can be determined by computing the weight gradient by optimizing the regularization term by using gradient descent to optimize parameters when the fine-tuned LLM 317 is trained with domain knowledge.

To optimize parameters during forward pass using gradient descent when the fine-tuned LLM 317 is trained with domain knowledge 320, the regularization term can be further reduced:

$${L}_{r e g} = λ {\sum }_{m = 1}^{M} {{G}^{m} ( {W}^{m} - α {g}_{next}^{m} - {W}^{m} )}^{2} = λ {\sum }_{m = 1}^{M} {α}^{2} {{G}^{m} ( {g}_{next}^{m} )}^{2}$$

where Wᵢ^{m} weight value of m-th index, after every parameter update and λ is a hyperparameter with default value of 1, Gᵢ^{m} is the importance score for the i-th node for the m-th index, α is the learning rate, gₙₑₓₜ^{m} as the gradient of each parameter with respect to Lₙₑₓₜ.

During backward pass, optimizing the regularization term requires second-order derivatives. To compute second-order derivatives, the gradient of the regularization with respect to every parameter matrix in a courser granularity can be obtained by using the average of the squared gradient of the model's prediction over P as approximate Fisher information:

$$\frac{\partial {L}_{r e g}}{\partial {W}^{m}} = 2 λ {α}^{2} {G}^{m} ∇ H \approx \frac{2 λ {α}^{2} {G}^{m}}{P} {g}_{n e x t}^{m} {\sum }_{j = 1}^{P} {( {g}_{n e x t}^{m} ( {X}_{j} , {Y}_{j} ) )}^{2}$$

where Wᵢ^{m′} denotes the updated weight value of Wᵢ^{m} after every parameter update and λ is a hyperparameter with default value of 1, Gᵢ^{m} is the importance score for the i-th node for the m-th index, a is the learning rate, gₙₑₓₜ^{m} as the gradient of each parameter with respect to Lₙₑₓₜ, P is a prediction as approximate Fisher information.

The final gradient computation of the regularized loss function can then be the derivatives of L(Ds), Lnext and Lreg:

$$\frac{\partial L ( {D}_{s} )}{\partial {W}^{m}} = \frac{\partial {L}_{n e x t}}{\partial {W}^{m}} + \frac{\partial {L}_{r e g}}{\partial {W}^{m}}$$

The final gradient computation of the regularized loss function can be used to determine importance weights for domain knowledge which can be used to prune unimportant nodes based on their importance weights.

In block 150, learned knowledge can be pruned based on importance weights for domain knowledge.

In an embodiment, learned knowledge can be pruned based on the final importance weights for domain knowledge 320. The final importance score can be defined as:

$$\vert \frac{\partial L ( {D}_{g} )}{\partial {W}_{i}^{m}} {W}^{m} + {\frac{1}{2 P} [ \frac{\partial L ( {D}_{s} )}{\partial {W}^{m}} {W}^{m} ]}^{2} + O ( ‖ {W}^{m} {‖}^{3} ) \vert$$

where general knowledge domains D_{g}={xⱼ, yⱼ}ⱼ₌₁ⁿ, domain-specific data Dₛ={xⱼ, yⱼ}ⱼ₌₁^{p}, p is the number of domain-specific dataset, n which is the dataset size used for training, and Wi stands for a weight matrix representing the importance of each weight at index m, and O( ) is a big-O function.

The final importance score considers both general and domain-specific knowledge through the optimized regularized training objective function.

The final importance scores computed for all weights can then be saved for every training epoch.

To prune learned knowledge, a sparsity threshold can be predetermined. For example, the sparsity threshold can be 50% which can result in having the smallest 50% of all importance scores to be pruned.

In block 160, a corrective action of a monitored entity can be performed by using the domain-compressed LLM.

In an embodiment, the corrective action can be obtaining patient-specific healthcare data summary and assist the healthcare professional to generate a medical diagnosis for a patient (e.g., monitored entity).

In another embodiment, the corrective action can be performing healthcare data language inference to help obtain patient-specific predictions regarding their healthcare data. In another embodiment, the artificial intelligence assistant can perform healthcare data information extraction to help obtain patient-specific predictions regarding their healthcare data by extracting relevant information from the healthcare data. In another embodiment, the corrective action can be performing healthcare data question answering to help obtain patient-specific predictions regarding their healthcare data by answering questions that can be generated from relevant information from the healthcare data

The present embodiments can also be employed in different fields such as legal, transportation, etc. For example, the corrective action can be predicting relevant information within a person's financial statement to determine the probate and non-probate assets to aid in generating the person's (e.g., monitored entity) will or trust. In another embodiment, the domain-compressed LLM, as an edge module installed in the computer system of a vehicle (e.g., monitored entity) connected to an online car trajectory monitoring system located in a cloud system, can be used to detect traffic signs to control the vehicle's trajectory as the corrective action.

The present embodiments improve LLMs by having optimized domain knowledge as performance of domain-specific tasks, such as patient healthcare data understanding and summarization, is faster and more efficient than conventional LLMs, while maintaining general knowledge (e.g., domain-shared tasks such as text identification). The present embodiments also improve LLMs with significant reduced parameter count (e.g., half the original size or even less) making it more cost-efficient for deployment even in environment with diminished computational resources, such as resource-constrained edge computing devices. The present embodiments also improve LLMs with versatile deployment across diverse domains such as healthcare, legal, etc. which enables generation of compressed domain-specific models catering to an array of applications such as language comprehension, information extraction, and question answering.

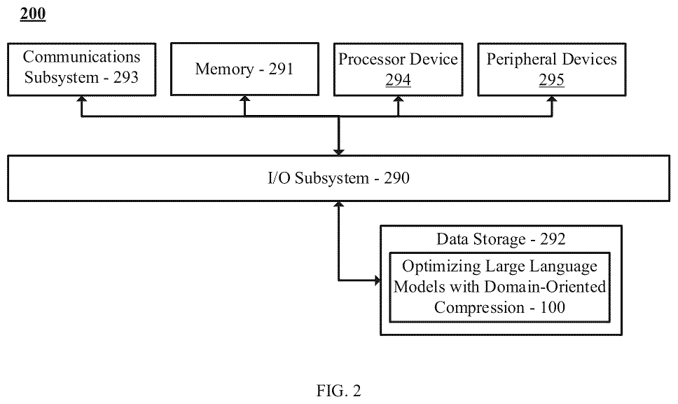

Referring now to FIG. 2, a block diagram of a system for optimizing large language models with domain-oriented model compression is illustratively depicted in accordance with an embodiment of the present invention.

The computing device 200 illustratively includes the processor device 294, an input/output (I/O) subsystem 290, a memory 291, a data storage device 292, and a communication subsystem 293, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 291, or portions thereof, may be incorporated in the processor device 294 in some embodiments.

The processor device 294 may be embodied as any type of processor capable of performing the functions described herein. The processor device 294 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 291 may be embodied as any type of volatile or non-volatile memory or data storage capable of performing the functions described herein. In operation, the memory 291 may store various data and software employed during operation of the computing device 200, such as operating systems, applications, programs, libraries, and drivers. The memory 291 is communicatively coupled to the processor device 294 via the I/O subsystem 290, which may be embodied as circuitry and/or components to facilitate input/output operations with the processor device 294, the memory 291, and other components of the computing device 200. For example, the I/O subsystem 290 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 290 may form a portion of a system-on-a-chip (SOC) and be incorporated, along with the processor device 294, the memory 291, and other components of the computing device 200, on a single integrated circuit chip.

The data storage device 292 may be embodied as any type of device or devices configured for short-term or long-term storage of data such as, for example, memory devices and circuits, memory cards, hard disk drives, solid state drives, or other data storage devices. The data storage device 292 can store program code for optimizing large language models with domain-oriented compression 100. Any or all of these program code blocks may be included in a given computing system.

The communication subsystem 293 of the computing device 200 may be embodied as any network interface controller or other communication circuit, device, or collection thereof, capable of enabling communications between the computing device 200 and other remote devices over a network. The communication subsystem 293 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 295. The peripheral devices 295 may include any number of additional input/output devices, interface devices, and/or other peripheral devices. For example, in some embodiments, the peripheral devices 295 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 200 are readily contemplated by one of ordinary skill in the art given the teachings of the present invention provided herein.

Referring now to FIG. 3, a block diagram illustrating a software implementation of optimizing large language models with domain-oriented model compression, in accordance with an embodiment of the present invention.

In an embodiment, general knowledge and domain knowledge can be considered during optimization to maximize the performance of a domain-compressed LLM in a software implementation 300. The domain compressed LLM can be trained in a task-agnostic fashion where a pre-training objective can be adopted, and next token prediction can be part of fine-tuning. General knowledge can be considered during fine-tuning and pruning by regularization. Domain knowledge can be learned through next token prediction and multiple task-specific training data. The pruning method employed can be unstructured pruning where query, key, value, and output projections of self-attention layers, and gate, down, and up projections of multi-layer perceptrons (MLP) can be considered for pruning.

To ensure that the trained LLM 301 can retain its general knowledge by pre-training with a general knowledge dataset 303, a general knowledge locator 305 can be employed to identify LLM nodes having importance scores related to general knowledge to obtain located general knowledge 307.

To train domain knowledge into the trained LLM 301, a domain compression module 311 can use a domain knowledge dataset 313 and a fine-tuning module 315 to obtain a fine-tuned LLM 317. To ensure that the fine-tuned LLM 317 can retain both general knowledge and domain knowledge, a domain knowledge locator 319 can consider located general knowledge 307 and can identify LLM nodes having importance scores related to domain knowledge to obtain located domain knowledge 320. To compress the model that enables cost-efficient deployment to resource-restricted environments, a model pruner 321 can be employed to remove nodes with low importance scores. The domain compression module 311 can iterative optimize the LLM until nodes with the lowest importance scores are pruned according to a sparsity threshold. After the sparsity threshold is met, the domain compression module can obtain a domain compressed LLM 331. The domain compressed LLM 331 can now perform downstream tasks 341 such as natural language inference 343, summarization 345, information extraction 347, and question answering 349. Other downstream language tasks can be performed.

The domain-compressed LLM 331 can be implemented in edge modules (e.g., smartphones, wearable devices, etc.) which can connect to a cloud system that can monitor a monitored entity.

The present embodiments improve LLMs by having optimized domain knowledge by performing domain-specific tasks faster and more efficiently than conventional LLMs while maintaining general knowledge. The present embodiments also improve LLMs with significant reduced parameter count (e.g., half the original size or even less) making it more cost-efficient for deployment even in environment with diminished computational resources, such as resource-constrained edge computing devices. The present embodiments also improve LLMs with versatile deployment across diverse domains such as healthcare, legal, etc., which enables generation of compressed domain-specific models catering to an array of applications such as language comprehension, information extraction, and question answering.

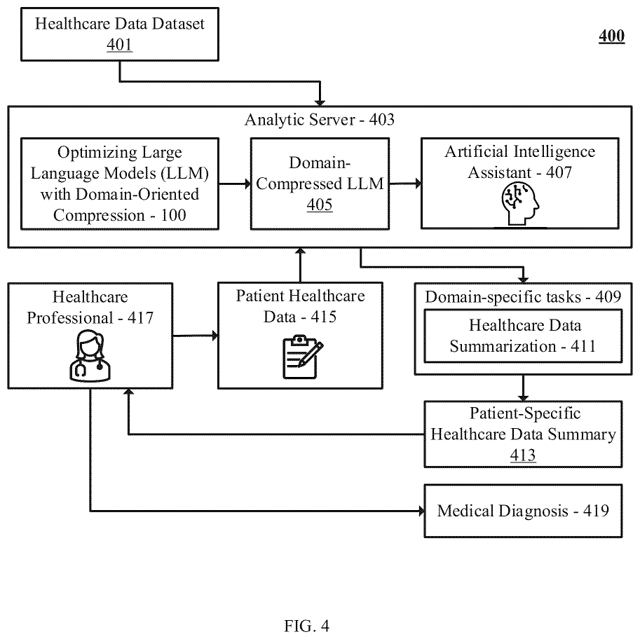

Referring now to FIG. 4, a block diagram illustrating a practical application of optimizing large language models with domain-oriented model compression in a healthcare setting, in accordance with an embodiment of the present invention

In an embodiment, the computer-implemented method for optimizing LLMs with domain-oriented model compression 100 can be practically applied to a healthcare setting. A healthcare data dataset 401 can be used to ensure that a domain-compressed LLM 405 has domain knowledge related to the healthcare data dataset 401 and general knowledge. The healthcare data dataset 401 can be sent to an analytic server 403 through a network. The analytic server 403 can be an edge module connected to a cloud system. The domain-compressed LLM can be employed by an artificial intelligence assistant 407 that can perform domain-specific tasks such as healthcare data summarization 411. For example, a patient healthcare data 415 can be sent by a healthcare professional 417 to the analytic server 403 through a network. The artificial intelligence assistant 407 can perform healthcare data summarization 411 to obtain patient-specific healthcare data summary 413 and assist the healthcare professional 417 to generate a medical diagnosis 419 for a patient.

In another embodiment, the artificial intelligence assistant 407 can perform healthcare data language inference to help obtain patient-specific predictions regarding their healthcare data. For example, if the healthcare data of a patient includes all symptoms for tuberculosis, the artificial intelligence assistant 407 can healthcare data language inference and predict that the patient has tuberculosis.

In another embodiment, the artificial intelligence assistant 407 can perform healthcare data information extraction to help obtain patient-specific predictions regarding their healthcare data by extracting relevant information from the healthcare data. For example, if the healthcare data of a patient includes all symptoms for tuberculosis, the artificial intelligence assistant 407 can perform information extraction to extract information related to the symptoms of tuberculosis which can be used to predict whether the patient has tuberculosis.

In another embodiment, the artificial intelligence assistant 407 can perform healthcare data question answering to help obtain patient-specific predictions regarding their healthcare data by answering questions that can be generated from relevant information from the healthcare data. For example, if the healthcare data of a patient includes all symptoms for tuberculosis, the artificial intelligence assistant 407 can perform question answering to answer questions related symptoms of tuberculosis (e.g., “does the patient have a cough?”) which can be used to predict whether the patient has tuberculosis.

The present embodiments can also be employed in different fields such as legal, transportation, etc. For example, a practical application for the legal field can be predicting relevant information within a person's financial statement to determine the probate and non-probate assets to aid in generating the person's will or trust. In another embodiment, the domain-compressed LLM, as an edge module installed in the computer system of a car connected to an online car trajectory monitoring system located in a cloud system, can be used to detect traffic signs to control a vehicle's trajectory.

Other practical applications are contemplated.

The present embodiments employ deep learning neural networks that improve the domain knowledge of a pre-trained LLM while maintaining its general knowledge and diminishing unnecessary model parameters to improve the performance, speed, and efficiency of the pre-trained LLM.

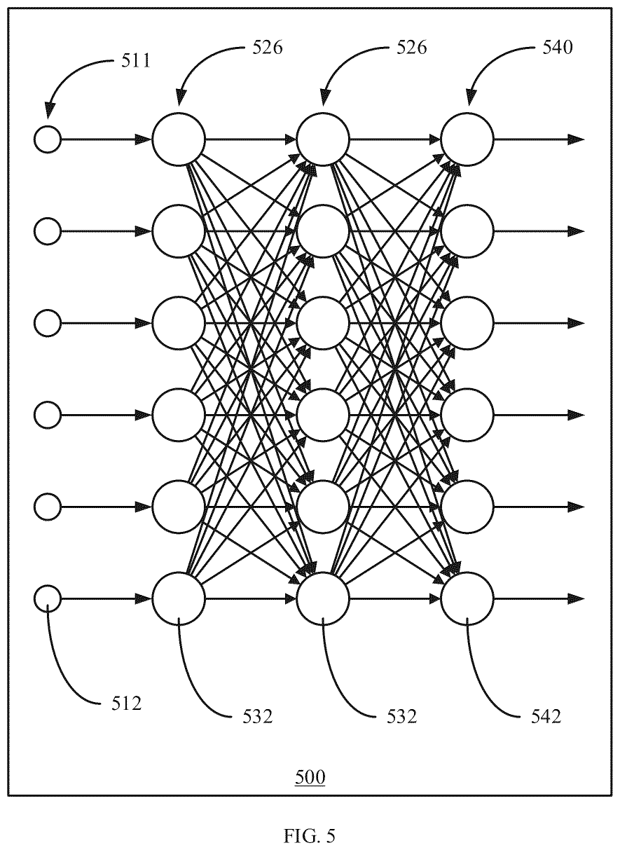

Referring now to FIG. 5, a block diagram illustrating deep learning neural networks for unsupervised multi-modal causal structure learning for root cause analysis for artificial intelligence operations of a cloud system, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 500, such as a multilayer perceptron, can have an input layer 511 of source nodes 512, one or more computation layer(s) 526 having one or more computation nodes 532, and an output layer 540, where there is a single output node 542 for each possible category into which the input example could be classified. An input layer 511 can have a number of source nodes 512 equal to the number of data values 512 in the input data 511. The computation nodes 532 in the computation layer(s) 526 can also be referred to as hidden layers, because they are between the source nodes 512 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

In an embodiment, the computation layers 526 of the trained LLM 301 can be used to learn domain knowledge from a domain knowledge dataset to fine-tune the trained LLM 301 and obtain a fine-tuned LLM 317 with located important nodes that learned both domain knowledge and general knowledge. The output layer 540 of the fine-tuned LLM 317 can then provide the overall response of the network as domain compressed LLM 331. In another embodiment, the domain compressed LLM 331 can be used to perform downstream tasks such as natural language inference, summarization, information extraction and question answering.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 526 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for optimizing large language models (LLM) with domain-oriented model compression, comprising:
determining importance weights for general knowledge in a trained LLM, pretrained with deep learning, by computing an error when removing a weight from the trained LLM;
optimizing the trained LLM iteratively to obtain a domain-compressed LLM with domain knowledge while maintaining general knowledge by:
fine-tuning the trained LLM with domain knowledge using the importance weights for general knowledge to obtain a fine-tuned LLM;
determining importance weights for domain knowledge in the LLM with a regularization term by using gradient descent to optimize parameters when the fine-tuned LLM is trained with domain knowledge;
pruning learned knowledge based on importance weights for domain knowledge; and
performing corrective action on a monitored entity using the domain compressed LLM.

2. The computer-implemented method of claim 1, wherein performing corrective action further comprises performing healthcare data summarization by employing the domain-compressed LLM to assist a decision making of a healthcare professional regarding health information text of a patient.

3. The computer-implemented method of claim 1, wherein determining importance weights for general knowledge further comprises employing a calibration dataset to evaluate the importance weights.

4. The computer-implemented method of claim 1, wherein fine-tuning the LLM further comprises training with a domain-specific dataset.

5. The computer-implemented method of claim 1, wherein fine-tuning the LLM further comprises adding a regularization term on top of a next token prediction loss to formulate a final training objective function.

6. The computer-implemented method of claim 1, wherein pruning learned knowledge further comprises calculating a final importance score by averaging a squared gradient of a fine-tuned LLM prediction over training instances as approximate Fisher information.

7. The computer-implemented method of claim 1, wherein pruning learned knowledge further comprises removing weights that have importance scores lower than a sparsity threshold.

8. A system for optimizing large language models (LLM) with domain-oriented model compression, comprising:
a memory device; and
one or more processor devices operatively coupled with the memory device to:
determine importance weights for general knowledge in a trained LLM, pretrained with deep learning, by computing an error when removing a weight from the trained LLM;
optimize the trained LLM iteratively to obtain a domain-compressed LLM with domain knowledge while maintaining general knowledge by further performing steps to:
fine-tune the trained LLM with domain knowledge using the importance weights for general knowledge to obtain a fine-tuned LLM;
determine importance weights for domain knowledge in the LLM with a regularization term by using gradient descent to optimize parameters when the fine-tuned LLM is trained with domain knowledge;
prune learned knowledge based on importance weights for domain knowledge; and
perform corrective action on a monitored entity using the domain compressed LLM.

9. The system of claim 8, wherein one or more processor devices operatively coupled with the memory device to perform corrective action further comprises to perform healthcare data summarization by employing the domain-compressed LLM to assist a decision making of a healthcare professional regarding health information text of a patient.

10. The system of claim 8, wherein one or more processor devices operatively coupled with the memory device to determine importance weights for general knowledge further comprises employing a calibration dataset to evaluate the importance weights.

11. The system of claim 8, wherein one or more processor devices operatively coupled with the memory device to fine-tune the LLM further comprises training with a domain-specific dataset.

12. The system of claim 8, wherein one or more processor devices operatively coupled with the memory device to fine-tune the LLM further comprises adding a regularization term on top of a next token prediction loss to formulate a final training objective function.

13. The system of claim 8, wherein one or more processor devices operatively coupled with the memory device to prune learned knowledge further comprises calculating a final importance score by averaging a squared gradient of a fine-tuned LLM prediction over training instances as approximate Fisher information.

14. The system of claim 8, wherein one or more processor devices operatively coupled with the memory device to prune learned knowledge further comprises removing weights that have importance scores lower than a sparsity threshold.

15. A non-transitory computer program product comprising a computer-readable storage medium including program code for optimizing large language models (LLM) with domain-oriented model compression, wherein the program code when executed on a computer causes the computer to:
determine importance weights for general knowledge in a trained LLM, pretrained with deep learning, by computing an error when removing a weight from the trained LLM;
optimize the trained LLM iteratively to obtain a domain-compressed LLM with domain knowledge while maintaining general knowledge by further performing steps to:
fine-tune the trained LLM with domain knowledge using the importance weights for general knowledge to obtain a fine-tuned LLM;
determine importance weights for domain knowledge in the LLM with a regularization term by using gradient descent to optimize parameters when the fine-tuned LLM is trained with domain knowledge;
prune learned knowledge based on importance weights for domain knowledge by removing weights that have importance scores lower than a sparsity threshold; and
perform corrective action on a monitored entity using the domain compressed LLM.

16. The non-transitory computer program product of claim 15, wherein to perform corrective action further comprises to perform healthcare data summarization by employing the domain-compressed LLM to assist a decision making of a healthcare professional regarding health information text of a patient.

17. The non-transitory computer program product of claim 15, wherein to determine importance weights for general knowledge further comprises employing a calibration dataset to evaluate the importance weights.

18. The non-transitory computer program product of claim 15, wherein to fine-tune the LLM further comprises training with a domain-specific dataset.

19. The non-transitory computer program product of claim 15, wherein to fine-tune the LLM further comprises adding a regularization term on top of a next token prediction loss to formulate a final training objective function.

20. The non-transitory computer program product of claim 15, wherein to prune learned knowledge further comprises calculating a final importance score by averaging a squared gradient of a fine-tuned LLM prediction over training instances as approximate Fisher information.
